(19) United States
(12) Patent Application Publication
(10) Pub. No.: US 2011/0188722 A1
(43) Pub. Date: Aug. 4, 2011

(54) SYSTEM AND METHOD FOR DIFFERENTIATING BENIGN FROM MALIGNANT CONTRAST-ENHANCED LESIONS

(75) Inventor: Jie HUANG, Okemos, MI (US)

(73) Assignee: Board of Trustees of Michigan State University, East Lansing, MI (US)

(21) Appl. No.: 13/016,344

(22) Filed: Jan. 28, 2011

Related U.S. Application Data
(63) Continuation-in-part of application No. PCT/US2009/052108, filed on Jul. 29, 2009.
(60) Provisional application No. 61/084,384, filed on Jul. 29, 2008.

(51) Int. Cl. G06K 9/00

(52) U.S. Cl. 382/131

(57) ABSTRACT

Methods for assessing contrast-enhanced lesions using a dynamic contrast-enhancing magnetic resonance imaging system are provided. A boundary of a contrast-enhanced lesion is objectively and automatically determined. The kinetic behavior of voxels is quantitatively examined. The wash-out volume fraction relative to the lesion volume is used as a biomarker to characterize the lesion as malignant or benign.

### CROSS-REFERENCE TO RELATED APPLICATIONS

This application is a continuation-in-part of International Application No. PCT/US2009/052108, filed on Jul. 29, 2009, which claims the benefit of U.S. Provisional Application No. 61/084,384, filed on Jul. 29, 2008. The entire disclosures of the above applications are incorporated herein by reference.

### INTRODUCTION

The present disclosure relates to dynamic contrast-enhancement magnetic resonance imaging for differentiating benign lesions from malignant lesions.

Magnetic resonance imaging (MRI) is a clinical diagnostic tool that allows for non-invasive imaging of internal structures of a subject. Dynamic contrast-enhancement magnetic resonance imaging (DCE-MRI) combines magnetic resonance imaging principles with the effects of paramagnetic contrast agents on a magnetic resonance signal to track the entrance of the diffusible contrast agents into tissue over time.

DCE-MRI has been shown to be very sensitive, particularly for small lesions, including, but not limited to, breast cancer lesions. DCE-MRI allows for easy viewing or enhancement of the lesion on a graphical display following an intravenous injection of paramagnetic contrast agents such as gadolinium diethylenetriamine-pentaacetic acid (Gd-DTPA). It is believed that the enhancement in malignant tumors is correlated with tumor angiogenesis.

Although DCE-MRI demonstrates high sensitivity to invasive breast cancers, one major limitation is the low specificity caused by the overlap in enhancement between benign and malignant lesions, resulting in a smaller positive predictive value (PPV) for biopsies. False-positive enhancement or prediction is frequently observed in many benign lesions including fibroadenomas, proliferative fibrocystic changes, atypical ductal hyperplasia, etc. This demonstrates that the presence of enhancement alone cannot be used to differentiate benign from malignant lesions. Accordingly, further characterization of the lesions is necessary to properly diagnose the lesions as malignant or benign.

### SUMMARY

The present technology provides methods for automatically determining an actual boundary of a contrast-enhanced lesion using a dynamic contrast-enhancement magnetic resonance imaging system including a graphical display, a user interface, and a processor. An outer boundary outside of the lesion and an inner boundary within the lesion are selected using a user interface on a graphical display of a first post-contrast image of an area surrounding the lesion. An initial region of interest located between the inner boundary and the outer boundary is selected to roughly cover the lesion. A mean (μ) and a standard deviation (σ) of a magnetic resonance signal intensity of voxels are calculated within the initial region of interest using a processor. A threshold value TH=μ−N×σ is calculated for voxels in the initial region of interest using the processor. The signal intensity of the voxels around the initial region of interest is compared with the threshold value using the processor. The size of the initial region of interest is modified based on the relative signal intensity of voxels in the area adjacent to the initial region of interest as compared to the threshold value to provide an updated region of interest using the processor. The initial region of interest is compared with the updated region of interest and repeating select steps until both regions interest are substantially the same to automatically determine the actual boundary of the lesion which is then displayed on the graphical display.

The present technology also provides methods for quantitatively characterizing kinetic features of a contrast-enhanced lesion using a dynamic contrast-enhancement magnetic resonance imaging system including a graphical display, a user interface, and a processor. The contrast-enhanced lesion is displayed on the graphical display. A linear fitting of a post-contrast signal intensity time course voxel-by-voxel is computed to provide a fitted line using the processor. The slope (m) and corresponding degree of the slope of the fitted line are computed. The degree of the slope is displayed on the graphical display and interpreted to characterize a wash-out behavior of the lesion. The lesion is then characterized as malignant, benign, or requiring further investigation based on the degree of the slope.

The present technology also provides methods for differentiating a benign lesion from a malignant lesion using a dynamic contrast-enhancement magnetic resonance imaging system having a graphical display, a user interface, and a processor. The contrast-enhanced lesion is displayed on the graphical display. A lesion volume is calculated by summing the total number of voxels in the lesion using the processor. Wash-out voxels are identified within the lesion. A wash-out volume is calculated by summing the total number of wash-out voxels within the lesion using the processor. The ratio of the wash-out volume and the lesion volume is calculated to provide a wash-out volume fraction value using the processor. The wash-out volume fraction value is compared to a threshold value to characterize the lesion as malignant or benign.

### DRAWINGS

The figures described herein are for illustration purposes only and are not intended to limit the scope of the present disclosure in any way.

FIG. 1 depicts a series of pre- and post-contrast images using dynamic contrast-enhancement magnetic resonance imaging;

FIG. 2 depicts a process of automatically selecting the size of a lesion;

FIG. 3 depicts a comparison of a lesion before and having the size selected;

FIG. 4 depicts a lesion after the kinetic analysis of wash-out;

FIG. 5 depicts the types of kinetic behavior of lesions;

FIG. 6 depicts a comparison of the histogram distribution of the kinetic behaviors of a malignant lesion and a benign lesion;

FIG. 7 depicts a comparison of wash-out volume fractions for malignant lesions and benign lesions; and

FIG. 8 depicts a scattered plot of a wash-out volume fraction against the lesion volume.

Corresponding reference numerals indicate corresponding parts throughout the several views of the drawings.

It should be noted that the figures set forth herein are intended to exemplify the general characteristics of an apparatus and methods among those of the present technology, for the purpose of the description of such embodiments herein. These figures may not precisely reflect the characteristics of any given embodiment, and are not necessarily intended to define or limit specific embodiments within the scope of this technology.

### DESCRIPTION

The following description of technology is merely exemplary of the subject matter, manufacture, and use of one or more inventions, and is not intended to limit the scope, application, or uses of any specific invention claimed in this application or in such other applications as may be filed claiming priority to this application, or patents issuing therefrom.

The headings (such as “Introduction” and “Summary”) and sub-headings used herein are intended only for general organization of topics within the disclosure of the technology, and are not intended to limit the disclosure of the technology or any aspect thereof. In particular, subject matter disclosed in the “Introduction” may include aspects of technology within the scope of the technology and may not constitute a recitation of prior art. Subject matter disclosed in the “Summary” is not an exhaustive or complete disclosure of the entire scope of the technology or any embodiments thereof.

The description and specific examples, while indicating embodiments of the technology, are intended for purposes of illustration only and are not intended to limit the scope of the technology. Moreover, recitation of multiple embodiments having stated features is not intended to exclude other embodiments having additional features or other embodiments incorporating different combinations the stated of features. Specific Examples are provided for illustrative purposes of how to practice the methods of the present technology, and unless explicitly stated otherwise, are not intended to be a representation that given embodiments of these technologies have, or have not, been made or tested.

As used herein, the words “preferred” and “preferably” refer to embodiments of the technologies that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the technology.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting ingredients, components or process steps, Applicants specifically envision embodiments consisting of, or consisting essentially of, such ingredients, components or processes excluding additional ingredients, components or processes (for consisting of) and excluding additional ingredients, components or processes affecting the novel properties of the embodiment (for consisting essentially of), even though such additional ingredients, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As used herein, the word “include,” and its variants, is intended to be non-limiting, such that recitation of items in a list is not to the exclusion of other like items that may also be useful in the methods of the present technology.

As used herein, the words “A” and “an” indicate “at least one” of the item is present.

As used herein, the word “about,” when applied to the value for a parameter of a method of the technology, indicates that the calculation or the measurement of the value allows some slight imprecision without having a substantial effect on the attributes of the described composition, device or method.

The present technology relates to methods of evaluating tumors and other lesions in human or other animal subjects. While certain embodiments relate to breast lesions, it is understood that the present technology is suitable for all lesions. Further, while small lesions are associated with breast lesions, the present technology is also applicable to lesions larger than 25 millimeters. It is understood that the various methods of the present technology can be used separately or together as a system to characterize a lesion.

Magnetic resonance imaging (MRI) non-invasively evaluates an internal system or tissue in a subject and provides a representative graphical display of the selected internal system or tissue. The graphical display for the MR image is in the unit of voxels or three-dimensional pixels which represent a unit of volume. The voxels represent the volume and features of the tissue in a target region.

The MRI systems used in the present technology include a graphical display, a user interface, and a processor. It is understood that other elements may also be included with the MRI system, such as a magnet, shim coils, and gradient coils, as well as appropriate elements for supporting a human or other animal subject to be imaged, and for the processing and display of imaging data. Such other elements include those comprised in MRI imaging systems among those known in the art. The graphical display used the systems of the present technology provides the visual output which is further manipulated or analyzed by the operator or by the processor. It is understood that other graphical outputs such as a printed page can also be used within the scope of the present technology. In various embodiments, a monitor is the graphical screen display. The processor performs various computational steps disclosed in the present technology. It is understood that the processor does not have to perform all of the computational steps and that the operator may perform certain steps, especially when the experience of the operator is necessary to make a subjective assessment or modification to a calculation. The user interface provides the operator with the ability to receive, input, or manipulate information from the MRI system. For example, the user interface for input and manipulation can include a keyboard, mouse, roller ball, touch screen, etc., through which the operator can make the various parameter selections required for the present technology. It is understood that the user interface can also include peripheral equipment through which the computer communicates with the operator. Any of the graphical display, processor, or user interface can be located near the MRI system, located remotely, or located over a network or the internet to accommodate analysis at the location of the MRI or at a remote location. It is also understood that the processing and data analysis of the present technology can be performed separately from the image and data collection using a separate processor and computer.

The present technology also provides dynamic contrast-enhancing magnetic resonance imaging systems comprising a graphical display, a user interface, and a processor, the system being operable for determining an actual boundary of a contrast-enhanced lesion in a subject using a method of the present technology. Such systems comprise components as described above, adapted or otherwise configured for performing the steps of such methods. For example, such components may comprise suitable software in a memory device which, when executed by the processor, effects one or more of the computing, calculating, comparing, modifying and comparing steps of the process.

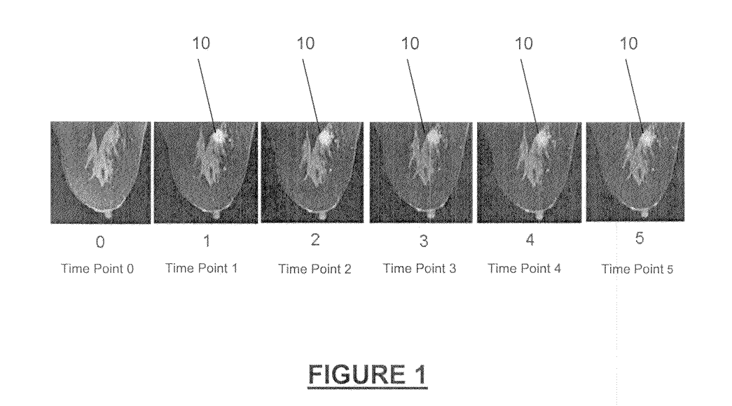

In direct contrast-enhancement magnetic resonance imaging (DCE-MRI), a paramagnetic contrast agent, such as gadobenate dimeglumine (Gd-BOPTA) or gadolinium diethylenetriamine-pentaacetic acid (Gd-DTPA), as non-limiting examples, is intravenously injected into the patient and carried to the targeted tissue via blood circulation. The contrast agent increases the magnetic resonance signal on the image or highlights or brightens the internal system or tissues on the graphical display. As the mean contrast agent concentration within a voxel increases, the magnetic resonance signal intensity from that voxel increases. Similarly, the MR signal intensity decreases when the mean contrast agent concentration decreases. These increases and decreases are directly shown on the MRI graphical display or screen shots as shown in FIG. 1. Time point 0 depicts a pre-contrast image where the contrast agent has not yet been added. The increase in the highlighting or brightening of the lesion is evident between time point 0 and time point 1 as lesion 10 is not visible in the pre-contrast image of time point 0.

Diffusion of the contrasting agent through the extravascular extracellular space is exemplified along the time points 1 through 5 of FIG. 1. Time point 1 is the first post-contrast image and is taken 30 seconds after the injection and diffusion of the contrasting agent into the extracellular space. Time point 1 has the strongest presence of the contrasting agent and increased intensity of the lesion 10. As illustrated, the presence of the contrasting agent diminishes as time elapses through subsequent time points 2 through 5. The contrast images for time points 1 through 5 are taken 90 seconds apart and demonstrate diffusion of the contrasting agent over time, as is detailed in a different graphical form later herein.

The diffusion of the contrasting agent is broadly categorized as “persistent enhancement,” “wash-out,” or “plateau.” As used herein, the “persistent enhancement” (PE) refers to an increase or accumulation of the contrast agent in the tissue as displayed through the voxels over time. As used herein, “wash-out” (WO) refers to the reduction of presence of the contrasting agent over time in the voxel as compared to a previous image of the voxel (for example from time point 2 to time point 4, in FIG. 1). The wash-out is depicted as an image which has a decreased highlighting of the lesion as compared to an image taken at a prior time point. The time point 5 is characterized as showing the wash-out of the contrast agent in the series of images of FIG. 1. As used herein, “plateau” (PL) refers to a steady state or presence of the contrasting agent over time.

It is known that contrast-enhancement in a lesion mainly reflects the degree of vascularization of the lesion. The increased vascularization or microvessels associated with the aggressive cancer cell growth produce a increase in signal intensity, making the cancer detection sensitively. Malignant tumors often demonstrate a rapid increase in the magnetic resonance signal intensity and then reach a peak around 1-3 minutes followed by a wash-out or plateau behavior on post-contrast images. Most benign lesions exhibit a slower but persistent enhancement of the signal intensity without the wash-out behavior.

The present technology provides methods which can work together or separately to improve dynamic contrast-enhanced magnetic resonance imaging using the graphical display or calculations based on the graphical display. The various methods provide a tangible graphical display which can be used to provide subsequent interpretable graphical display or information and to better assess whether a lesion is malignant or benign. The methods provide an enhanced sensitivity to the lesion assessment and allow a technician to better contour the location and features of the lesion. Subsequently, the present methods significantly reduce the false-positive results frequently observed in many benign lesions including fibroadenomas, proliferative fibrocystic changes, atypical ductal hyperplasia, lobular neoplasia, etc. from prior MRI analysis techniques.

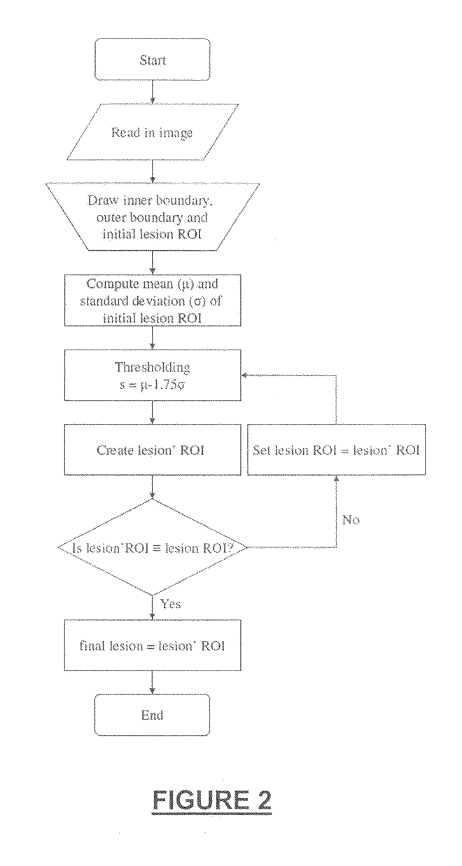

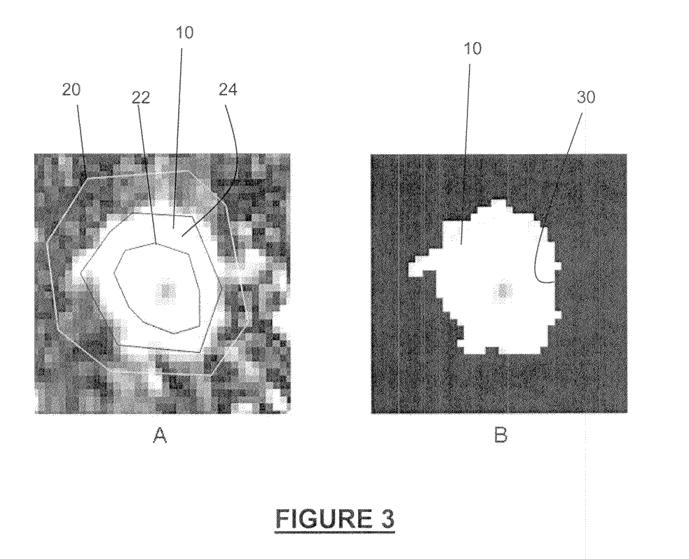

Turning to FIGS. 2 and 3, in various embodiments, the present technology provides methods for automatically and objectively determining a boundary of a contrast-enhanced lesion 10 using dynamic contrast-enhancement magnetic resonance imaging. Determining the boundary of the contrast-enhanced lesion 10 allows for objective diagnosis of only the most important areas of interest while extraneous and non-malignant tissues are deselected without the repeated and laborious input of a technician. The technician or operator merely selects a region for analysis and manually selects basic parameters. The method then provides the automated narrowing of the shape of the lesion 10 to prevent wasted efforts or analysis of tissue which is a false predictor of malignancy of the lesion 10.

With specific reference to FIG. 3, a magnetic resonance image of a tissue of interest is read and placed on a graphical display on which the tissue is represented by a series of voxels. The operator manually draws or selects an outer boundary 20 outside of the lesion 10 and an inner boundary 22 within the lesion. This selection can be on the first post-contrast image of the tissue area surrounding the lesion 10, such as the time point 1 image of FIG. 1. The operator makes the selection using a user interface such as a mouse, keyboard, or touch screen, as non-limiting examples. The area to be selected is identified based on the highlighting of the area from the contrast agent. It is understood that subsequent contrast images can also be used in the present methods. After selection of the boundaries 20, 22 with the user interface, the graphical display shows the selections.

Between the inner boundary 22 and the outer boundary 20, there is an initial region of interest 24. The initial region of interest 24 is the first place in which to further study the lesion and as detailed later herein, to either include or exclude additional tissues on the graphical display to precisely determine the size of the lesion for subsequent evaluation. The initial region of interest 24 can roughly cover the lesion such as a portion of the lesion or the initial region of interest 24 can cover the entire lesion 10.

A mean (μ) and a standard deviation (σ) of a magnetic resonance signal intensity of voxels are calculated within the initial region of interest. The mean and standard deviation are used to provide a threshold value (TH) for the voxels in the initial region of interest. The threshold value is the metric upon which the additional voxels are included in or excluded from the initial region of interest 24. The threshold value is calculated using the following formula: TH=μ−N×σ. In various embodiments, the N value is from about 1 to about 3, including all subranges and points therebetween. In some embodiments, the N value is about 1.75. It is understood that modifications to the N value can be made based on the Hertz value used for the evaluation, as a non-limiting example.

After the threshold value is determined, the signal intensities of the voxels around the initial region of interest 24 are compared with the threshold value to provide an updated region of interest (not shown). Voxels having a signal intensity larger than the threshold value are incorporated into an updated region of interest. Voxels having a signal intensity that is smaller than the threshold value are excluded from the updated region of interest.

The initial region of interest 24 is compared with the updated region of interest and repeating the steps of selecting a new region of interest through modifying the size to provide an updated region of interest until both regions interest are substantially the same. In various embodiments, an updated region of interest which has a signal intensity or region size of about 95% of the threshold value would be considered substantially the same. The initial region of interest 24 is compared to the updated region of interest and various steps are repeated until both regions of interest are identical. During the iterative process, the initial region of interest is replaced with the updated region of interest prior to repeating the analysis. This iterative process automatically determines the boundary of the lesion. In various embodiments, the operator has the option to stop the iterative process for an intermediate assessment.

This process facilitates an operator refining the dimensions of a suspicious area and refining the lesion which is to be subsequently evaluated. As compared to prior methods in which the operator had to manually select areas, the threshold value and automatic reassignment of the initial and updated regions of interest provide an expedited and more reliable identification of the boundaries of a lesion 10. As shown in FIG. 3, image B shows the screen display of the contoured final or actual boundary 30 of the lesion 10 and replaces the initial background with a solid background. This lesion 10 can then be further studied for classification as malignant or benign without unnecessary resources being used to evaluate voxels which are not part of the lesion 10 or could otherwise produce a false positive result.

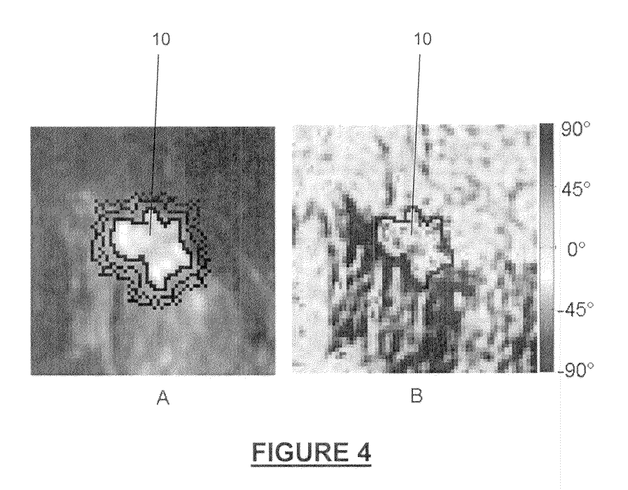

Turning to FIGS. 4 through 7, in various embodiments, the present technology also provides methods for quantitatively characterizing kinetic features of a contrast-enhanced lesion using dynamic contrast-enhancement magnetic resonance imaging. Technologies in the art only provide qualitative techniques for characterizing the kinetic features. Such qualitative technologies are limited by the experience of the operator or technician and also by the display. By quantitatively analyzing the kinetic features of the contrast-enhanced lesion, there is improved classification of the lesion and also reduced false positive results. Further, the present quantitative methods exploit the increased vascularization or microvessels associated with the increased magnetic resonance signal intensity of malignant lesions. Instead of being limited to the qualitative examination of wash-out or plateau behavior of the post-contrast images, the timing and signal intensity are analyzed quantitatively by the processor of the magnetic resonance imaging system, as a non-limiting example. This exploits the malignant tumors which demonstrate a rapid increase in the magnetic resonance signal intensity and then reaching a peak around 1-3 minutes followed by a wash-out or plateau behavior on post-contrast images and the benign lesions which exhibit a slower but persistent enhancement of the signal intensity without the wash-out behavior.

A linear fitting of a post-contrast signal intensity over time (time course) voxel-by-voxel is computed to provide a fitted line. The plotting can be conducted using the least squares method, as a non-limiting example. After obtaining the fitted line, the slope (m) is calculated. The corresponding degree of the slope of the fitted line is computed with the following formula: α=atan(m)×180/π. The degree of slope correlates to the degree between the horizontal axis and the fitted line.

The degree of the slope is interpreted to characterize a wash-out behavior of the lesion. Where the corresponding degree of the slope is a negative value (or less than zero), the lesion can be characterized as suspicious malignant. The negative value indicates there is a high degree of wash-out or reduction in the concentration of the contrast agent in the tissue over a period of time. This reflects the high vascularity shown in malignant lesions. Thus, the lesion is noted as being suspicious malignant and further characterization may optionally be conducted to confirm that the lesion is actually malignant. It is understood that while a negative value can be a degree of less than zero, if a benchmark were set at 15 degrees, for example, any angle less than the 15 degrees would relatively indicate a negative value and be indicative a suspicious malignant lesion. Where the corresponding degree of the slope is a positive value (greater than zero), the lesion can be characterized as suspicious benign. The positive degree of the slope indicates the persistent enhancement that is traditionally seen in benign lesions.

With reference to FIG. 4, the graphical display indicating the slope can be coded to inform the operator of the degree of the slope on a graphical display. As a non-limiting example, the coding can be color coded using one or different colors, or it can be coded in a gray-scale or other distinguishable manner. As shown in image B, the scale extends from 90 degrees to −90 degrees (shown in gray-scale of an originally color image for illustrative purposes). The negative degree of the slope (less than zero) indicates wash-out.

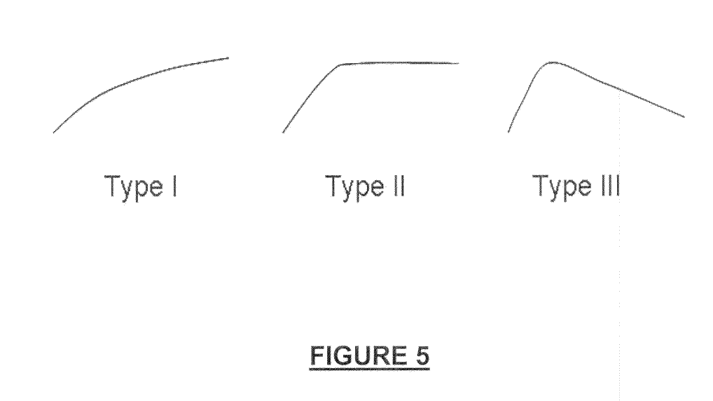

Example sloped lines are show in FIG. 5. Type I illustrates a persistent enhancement, where the concentration of the contrasting agent in the tissue increases over time. The slope of this line provides an indication that the lesion is suspicious benign or benign. Type II illustrates a plateau, where the concentration of the contrasting agent in the tissue briefly increases and then reaches a steady state. The slope for plateau lines tend to be a mixture of malignant and benign tumors and requires further evaluation. Type III illustrates a wash-out, where the concentration quickly increases and then sharply declines (or has a negative slope) over time. The slope for Type III lesions generally corresponds to a suspicious malignant or malignant lesion. It is shown that Type III has an increased density in microvessels which further corroborates the presence of a suspicious malignant or malignant lesion.

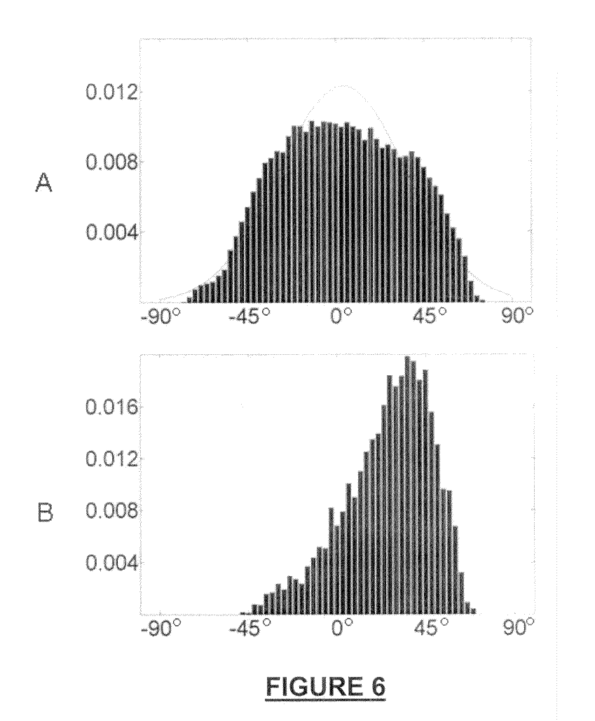

Turning to FIG. 6, chart A indicates the Gaussian distribution of the degree of the slope for a malignant tumor. There is a distribution of the peak from about −45 degrees to about 45 degrees. Chart B of FIG. 6 shows the Gaussian distribution of the degree of the slope for a benign tumor. The distribution is skewed towards the range of zero degrees to about 45 degrees. A histogram of slope degree distribution can be further computed for each lesion, summing pixel values for all slices covering the lesion, and then a final group histogram computed for the malignant tumors and the benign lesions, respectively, as shown in FIG. 3. As a non-limiting example, the group histogram for the malignant tumors (chart A) shows an approximate Gaussian distribution with μ=3.65° and σ=32.39°. This approximate Gaussian distribution establishes a kinetic feature-based statistical model. Statistical analyses show that the kinetic feature-based model facilitates differentiating benign from malignant enhancing breast lesions, so to reduce the false-positive error and consequently increasing the positive predictive value of biopsy.

In still further embodiments, the present technology also provides methods for differentiating a benign lesion from malignant lesion using dynamic contrast-enhancement magnetic resonance imaging. A lesion volume is calculated by summing the total number of voxels in the lesion. Wash-out voxels are identified within the lesion using methods disclosed earlier. A wash-out volume is then calculated by summing the total number of wash-out voxels within the lesion. The ratio of the wash-out volume and the lesion volume is calculated to provide a wash-out volume fraction value.

Accordingly, the wash-out volume fraction relative to the whole lesion volume serves as a biomarker for indicating the degree of hypervascularization associated with tumor angiogenesis. Accordingly, the ratio can be used to characterize the lesion as malignant or benign. In some instances, benign proliferative breast disease can also produce the wash-out curve, yielding an overlap between benign and malignant lesions and making them indistinguishable. The wash-out volume fraction of the benign proliferation might be relatively small in comparison to that of tumor angiogenesis, considering that an aggressive cancer cell growth is most likely accompanied with a relatively larger angiogenesis. Thus, measuring the wash-out volume fraction helps in differentiating benign from malignant contrast-enhanced lesions.

The wash-out can be characterized by a negative slope as indicated and as calculated above. A threshold value can be set for defining what levels of wash-out are of particular interest. A threshold value for defining the wash-out volume fraction can also be calculated. An exemplary threshold value and application of the threshold value can be to characterize the lesion as malignant if the wash-out volume fraction is greater than about 20%. If the wash-out volume fraction value is less than about 20%, the lesion can be characterized as benign. To assist in setting the threshold value to characterize the lesion, a scattered wash-out volume fraction versus the lesion volume can be plotted.

The wash-out volume fraction of a contrast-enhanced lesion is significantly different between the benign lesions and the malignant tumors. This provides a sensitive biomarker for differentiating benign from malignant contrast-enhancing breast lesions. The wash-out volume fraction serves as an improved predictor and significantly improves the prediction, reduces false-positive predictions, and consequently, significantly reduces unnecessary biopsies.

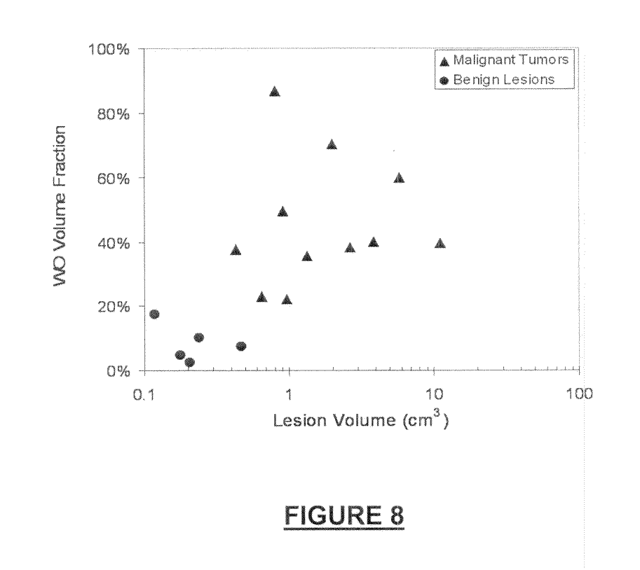

FIG. 8 shows a scatter plot of WO volume fraction versus lesion volume, demonstrating the separated distribution for the malignant tumors and the benign lesions. The scatter plot would be displayed on the graphical display or printed to allow the operator to assess the lesions. The distribution for the malignant tumors demonstrates that there is no declining trend in the wash-out volume fraction as the lesion volume increases, reflecting the increased tumor angiogenesis with malignant tumor growth. In contrast, considering that benign proliferative breast diseases and fibroadenoma do not in general progress proportionally with benign lesion development, it is believed that the WO volume fraction for benign lesions generally decreases with increasing the lesion volume, consistent with the distribution for the benign lesions in FIG. 8. This scattered plot can also be used to differentiate benign from malignant contrast-enhancing lesions by establishing a boundary to separate the two groups.

### Experimental Examples

### Materials and Methods

Patient Selection

Patients who underwent standard clinical breast MRI examination at Michigan State University (MSU) Radiology were screened for abnormal contrast-enhancing breast lesions. A lesion was included in this study if it met the following criteria: (1) It was radiologically reported as suspicious for malignancy; (2) it was larger than 7 mm in size and (3) its pathology report was available for comparison. The study included two primary classifications of lesions: (1) malignant tumors histologically diagnosed as infiltrating invasive ductal carcinoma and (2) benign lesions diagnosed as either fibrocystic disease or fibroadenoma. A total of eleven malignant tumors and six benign lesions involving fifteen patients were included in this study. One patient had two lesions: one malignant tumor on one breast and one benign lesion on the other breast. The study was approved by the MSU Institutional Review Board for Research Involving Human Subjects. Informed consent was obtained from all participants and the patient data were handled in compliance with HIPAA.

Magnetic Resonance Imaging (MRI)

Imaging was performed on a GE 1.5 T clinical scanner (General Electric HealthCare, Milwaukee, Wis.) using a dedicated bilateral 8-channel breast array coil. The patients were positioned feet-first in a prone position with the breasts suspended within the coil. An intravenous line was established before imaging for later delivery of gadobenate dimeglumine (Gd-BOPTA) contrast agent (0.2 mL/kg), and the contrast agent was injected at a rate of 3 cc/s over 7-10 seconds followed by a 20-cc saline solution flush. One set of pre-contrast images was acquired immediately prior to the administration of the contrast agent. The contrast agent injection and the dynamic imaging were synchronized, and the first post-contrast phase was initiated after a 30 second scan delay. Post-contrast imaging included five phases with a scan time of 90 seconds for each phase. The total scan time for post-contrast imaging was 7.5 minutes. Dynamic images were acquired in the axial plane using a 3-D, fat-suppressed T1-weighted fast spoiled-gradient-echo pulse sequence with the following parameters: TE/TR=2.8/5.9 ms, FOV 320 mm, Matrix 320×320, FA 10°, Slice thickness 2 mm, NEX 0.76, and ZIP2.

Motion Correction

Possible motion artifacts due to breathing or unexpected body movements were examined between the different phases via comparing the shape of apparent breast landmarks such as nipples. Any shift perpendicular to the image plane was examined first; there was no substantial shift in the data. The existence of in-plane shift in other phases relative to the first post-contrast phase was also examined. Small shifts in both directions were noticed and subsequently corrected. Software was used to correct these in-plane motion artifacts by shifting the examined image in both directions until a best possible overlap of the landmarks inside the lesion was found between the examined image and the reference image. The mean shift in anterior/posterior direction was 0.55 pixels (0.34 mm) with a maximum shift of 3 pixels. The mean shift in left/right direction was 0.25 pixels with a maximum shift of 2 pixels.

Lesion Determination

The contrast-enhanced lesions on the first phase post-contrast images were identified and confirmed by a board-certified radiologist. For each lesion, the boundary of the lesion on each slice was automatically determined using an in-house developed, MATLAB-based software. First, an inner-boundary within the lesion and an outer-boundary outside of the lesion were manually drawn, and then, a region of interest (ROI) was drawn to roughly cover the lesion. Second, the software computed the mean (μ) and standard deviation (σ) of the signal intensity of the pixels within the ROI. A threshold TH=μ−1.75σ (one-tail t-test, p<0.04) was computed, and then used to examine the pixels around the ROI. If a pixel's signal intensity was larger than TH, the pixel was included into the ROI. If the signal intensity was smaller than TH, the pixel was removed from the ROI. This resulted in a new ROI. The new ROI was limited to between the predetermined inner- and outer-boundaries. Then, the software computed μ and σ for the new ROI, and iterated the process automatically until a stable ROI was reached. Finally, this stable ROI was used to represent the lesion. After having found the lesion area, a layer of one pixel width was generated as a gap between the lesion and the surrounding tissue. A same area size (the same pixel numbers) as the lesion area size was generated in the surrounding tissue to represent a ROI for the surrounding tissue. The lesion ROI and the surrounding tissue ROI were separated by the gap represented by the inner ring in FIG. 3. A second ROI with the same area size was also generated outside the first ROI as shown in FIG. 3. The signal intensities of the three ROIs were computed for testing the reliability of lesion boundary detection.

Data Processing and Analysis

To examine the kinetic behavior of the lesions, a linear fitting of the signal intensity time course of the five phases was conducted using the method of least-squares, and then the slope (m) of the fitted line was computed pixel-by-pixel. The value for the interval between two consecutive phases was chosen as 80, which was found to yield the best scattered distribution of slopes for both lesion and the surrounding tissue. (Note that this Value can be Chosen Arbitrarily, Depending on the Choice of the Slope Unit.) Then, the corresponding degree (a) of the slope was computed using α=atan(m)×180/π. A histogram of slope degree distribution was further computed for each lesion, summing pixel values for all slices covering the lesion, and then a final group histogram was computed for the malignant tumors and the benign lesions, respectively (FIG. 6). As shown in FIG. 6, Chart A, the group histogram for the malignant tumors showed an approximate Gaussian distribution with μ=3.65° and σ=32.39°. This approximate Gaussian distribution enabled us to establish a kinetic feature-based statistical model. Statistical analyses were performed to test whether this introduced kinetic feature-based model could differentiate benign from malignant enhancing breast lesions, so to reduce the false-positive error and consequently increasing the positive predictive value of biopsy.

To test the reliability of this model, a different cut-off boundary of 16% probability for both Type I and Type III clusters was chosen, leaving a 68% probability for Type II cluster. Theoretical prediction and experimental observation were further compared. The WO behavior was further analyzed between the malignant tumors and the benign lesions.

### Results

The reproducibility of the method to automatically determine the boundary of a contrast-enhanced lesion was tested. First, the method was tested without placing an inner- and an outer-boundary to limit the boundary of the lesion. Five threshold values (TH=μ−1.25σ, μ−1.5σ, μ−1.75σ, μ−2.0σ, and μ−2.25σ) were tested for the determination of the lesion ROI. Their corresponding p-values (one-tail t-test) are 0.106, 0.067, 0.040, 0.023, and 0.012, respectively. The very first threshold value produced a ROI that was much smaller than the lesion, and the very last threshold value produced a ROI that was much larger than the lesion. All middle three threshold values produced a reasonable lesion ROI. The reproducibility of the determined lesion ROI was tested by varying the initially drawn area that roughly covered the lesion. The threshold TH=μ−1.756 produced the most stable lesion boundary that was almost independent of the roughly drawn lesion area, resulting in an objective lesion ROI. To ensure that the method would always produce a desired lesion ROI, one inner- and one outer-boundary were placed into the method. The inner-boundary ensures that the obvious inner part of the lesion would be included in the determined lesion ROI. The outer-boundary enables exclusion of those parts that should not be included in the final lesion ROI. With these two inner- and outer-boundary limitations and the threshold TH=μ−1.75σ, over 180 tests showed that this method always produced a stable lesion ROI.

To test the reliability of the method for the lesion determination, the signal intensity of the first post-contrast image was compared between the lesions and their surrounding tissues. The main signal intensity was 1582±334 (μ±σ) for the lesions, 673±161 for the tissue ROI 1, 583±142 for the tissue ROI 2, respectively. The main signal intensity of the lesions was significantly larger than that of the surrounding tissues (t-test, p<10-7), but no significant difference was observed between the tissue ROI 1 and the tissue ROI 2 (p>0.10), showing the reliability of the method for determining the lesion boundary. It provided a reliable method for objectively differentiating contrast-enhanced lesions from surrounding tissues.

To compare the malignant tumors with the benign lesions, the relative uptake signal change (wash-in rate) between the first post-contrast image (I1) and the pre-contrast image (I0), i.e., (I1−I0)/10, was computed. The wash-in rate was 111±39(%) for the benign lesions and 50±20(%) for their surrounding tissue ROI 1, and the difference was significant (p<0.009), confirming the reliability of the lesion determination. Similarly, the wash-in rate was 140±33(%) for the malignant tumors and 62±27(%) for their surrounding tissue ROI 1, and the difference was also significant (p<10-4). However, no significant difference was observed between the benign lesions and the malignant tumors (p>0.16), consistent with the radiologic reports of suspicious for malignancy. The corresponding relative signal change time courses for the malignant tumors, the benign lesions, and the tissue ROI 1 and ROI 2 were plotted and demonstrate the dramatic different kinetic behaviors between the lesions and the surrounding tissues, further confirming the reliability of lesion boundary determination using the presented method. The kinetic behavior of the benign lesions behaved similarly as that of the malignant tumors, making it difficult if not impossible to differentiate them. This result is consistent with that all of the lesions were radiologically reported as suspicious for malignancy.

To compare the kinetic features between the benign lesions and the malignant tumors, the mean kinetic curves for WO, PL and PE were plotted. All three kinetic curves showed the similar features between the malignant tumors and the benign lesions. For both the malignant tumors and the benign lesions, the WO cluster had the largest uptake signal intensity change, followed by the PL cluster and then the PE cluster. The WO cluster represented the most enhanced area within the lesion, and showed the typical Type III behavior for both the malignant tumors and the benign lesions. Accordingly, if the most enhanced area was selected as a ROI for the lesion diagnosis, the typical Type III behavior of the ROI for the benign lesions would characterize them as highly suspicious for malignancy, as confirmed with their radiologic reports, rendering the diagnosis as a false positive error. A further computation showed that the wash-in rate of the WO cluster was 135±66(%) for the benign lesions and 168±37(%) for the malignant tumors, and the difference was not significant (p>0.30).

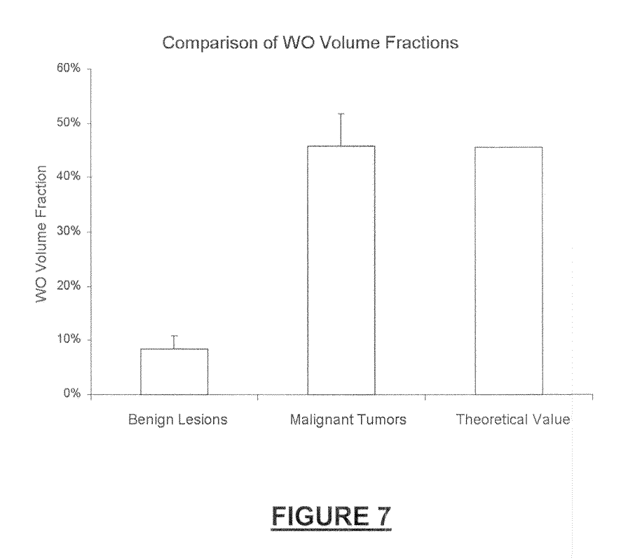

Although the benign lesions and the malignant tumors showed a similar wash-in rate with the similar kinetic features, the relative amount of WO pixels was subsequently different from each other, as depicted in FIG. 6. To measure this difference the ratio of the cluster volume to the whole lesion volume, defined as the volume fraction, was computed. For the malignant tumors, the volume fraction was 30.2±19.8(%) for WO, 43.5±15.7(%) for PL, and 26.3±12.0(%) for PE, respectively (FIG. 7). These values fairly agree with their corresponding theoretical values: 25%, 50%, and 25%, respectively. The mean WO volume fraction of 30.2% is slightly larger than the theoretical value of 25%. For the benign lesions, however, the volume fraction was 2.9±3.0(%) for WO, 32.7±14.5(%) for PL, 64.5±17.1(%) for PE, respectively. The WO volume fraction of the benign lesions was significantly smaller than that of the malignant tumors (p<0.0016), but the PE volume fraction of the former was significantly larger than that of the later (p<0.0013), reflecting the differences in the histograms (FIG. 2). There was no significant difference in the PL volume fraction between the benign lesions and the malignant tumors (p>0.19). The significant different WO volume fraction between the benign lesions and the malignant tumors has the potential to be utilized for differentiating benign from malignant contrast-enhancing breast lesions.

In this study the positive predictive value (PPV) of biopsies (the number of cancers detected divided by the number of biopsies performed) was 69% (11/16). The observed significant difference in the WO volume fraction between the benign lesions and the malignant tumors could be utilized to differentiate them from each other, and consequently to improve PPV significantly. For example, if the 90th percentile of sensitivity of the WO volume fraction for the determination of malignant tumors is selected, then the threshold volume fraction would be 4.9%. Using this threshold, 83% (5/6) of the benign lesions would be excluded for biopsy, resulting in a significantly improved PPV.

The reliability of the presented statistical model was tested with a different cut-off boundary of 16% probability for both the Type I and III curves. For the malignant tumors, the volume fraction was changed to 21.0±16.0(%) for WO, 61.7±14.7(%) for PL, and 17.7±9.8(%) for PE, respectively. The change rate of the volume fraction from the 25% cut-off boundary to the 16% cut-off boundary was −30.5% for WO, 41.8% for PL, and −32.7% for PE, respectively. These values fairly agree with their corresponding theoretical values: −36% for WO, 36% for PL, and −36% for PE, respectively. For the benign lesions, the volume fraction was changed to 1.0±1.0(%) for WO, 52.3±21.2(%) for PL, 46.5±22.3(%) for PE, respectively. The WO volume fraction of the benign lesions remained to be significantly smaller than that of the malignant tumors (p<0.004), and the PE volume fraction of the former remained to be significantly larger than that of the later (p<0.024). The difference in the PL volume fraction between the benign lesions and the malignant tumors remained to be not significant as expected (p>0.36).

Another way to test the reliability of the presented statistical model is to compute the volume fraction for those pixels with α<0° and compare it with the theory. For the malignant tumors, the corresponding volume fraction was 45.8±19.7(%), which agrees excellent well with the theoretical value of 45.6% (FIG. 7). For the benign lesions, however, the corresponding volume fraction was 8.4±5.7(%) which is significantly smaller than that for the malignant tumors (p<0.0001). These results can also be used to characterize contrast-enhancing breast lesions. If 20% is selected as the volume fraction threshold for characterizing these lesions, i.e., a volume fraction larger (smaller) than the threshold would be characterized as malignant (benign), then all of the malignant tumors would be identified as malignant and all of the benign lesions as benign.

The different histogram distributions in FIG. 6 can be used to produce quantitative measures for differentiating benign from malignant contrast-enhancing breast lesions. The mean slope can be such a measure. From the distributions in FIG. 6, the mean slope would be expected to be around μ=3.65° for the malignant tumors. However, a much larger mean slope value would be expected for the benign lesions. The measured mean slope was 3.4°±12.7° and ranged from −24.5° to 15.9° for the malignant tumors. It was 33.1°±8.3° and ranged from 23.6° to 46.1° for the benign lesions. The difference between the two groups was significant (p<0.0001), and there was no overlap between them. Consequently, the benign lesions were separated from the malignant tumors.

### DISCUSSION AND CONCLUSIONS

In this study, methods to automatically determine the boundary of a manually selected contrast-enhanced breast lesion are presented, resulting in a lesion ROI for the evaluation of the lesion (FIG. 3). The lesion ROI was determined based on the contrast-enhanced signal intensity of the lesion relative to its surrounding tissue, and the determination was objective. The tests showed that the method was reliable and reproducible. The signal intensity time course of the lesion ROI showed a dramatic different kinetic behavior in comparison to that of the surround tissue ROI, showing a successful separation of the lesion from its surrounding tissue. The lesion determination and subsequently the analysis of the signal intensity time course of the lesion were objective, independent of the investigators.

Histogram analysis of the slope degree of the contrast-enhanced signal intensity time course for the malignant tumors showed an approximate Gaussian distribution that established the presented kinetic feature-based statistical model for differentiating benign from malignant contrast-enhancing breast lesions (FIG. 6). The measured mean WO volume fraction for the malignant tumors fairly agreed with the model predicted value, but the measured mean WO volume fraction for the benign lesions was found to be significantly smaller than that for the malignant tumors (FIGS. 7 and 8). This significant difference could be utilized to confidently rule out almost all of the benign lesions as suspicious for malignancy, significantly improving the PPV of biopsies and reducing unnecessary biopsies.

The kinetic feature analysis showed the co-existence of WO, PL and PE behaviors within a lesion for both the malignant tumors and the benign lesions, demonstrating that it is very difficult if not impossible to differentiate benign from malignant contrast-enhancing lesions using the kinetic features alone. In addition, in comparison with the surrounding tissues, the wash-in rate was significantly larger for both the malignant tumors and the benign lesions, but no significant difference between the two groups, rendering the differentiation of benign from malignant in difficulty. These findings are consistent with the radiologic report of suspicious for malignancy for these lesions. It showed that, although the initial uptake signal change and the WO curve are very sensitive factors for diagnosing malignant tumors as proved in many studies, they alone would produce a large false-positive rate that resulted in a low PPV. Including other features such as the lesion morphology might not help at all since all these lesions were radiologically reported as suspicious for malignancy. This study showed that, however, the WO volume fraction might be a sensitive biomarker for differentiating benign from malignant contrast-enhancing lesions that could significantly improve the PPV.

The WO volume fraction was considered to reflect the degree of hypervascularization associated with tumor angiogenesis. With the chosen 25% threshold for the WO volume fraction, nine out of the ten malignant tumors had a measured WO volume fraction close to or larger than the theoretical value of 25%, ranged from 14.7% to 69.9%. Although the outlier had a 2.4% WO volume fraction that is much smaller than the theoretical value, its PL volume fraction was 78.5% which, however, is much larger than the theoretical value of 50%. The sum of the WO and PL volume fractions is 80.9, which is larger than the theoretical value of 75%, suggesting a suspicious for malignancy. In contrast to the malignant tumors, five out of the six benign lesions had a measured WO volume fraction much smaller than the theoretical value of 25%, ranged from 0.6% to 3.0%. Their corresponding PL volume fraction values were also much smaller than or close to the theoretical value of 50%, ranged from 9.9% to 43.2%. The similar results were obtained with the 16% threshold for the WO volume fraction, and the experimental results were in good agreement with the theoretical predictions (see Table 1). These results were hold true if the WO volume fraction was computed to include all pixels with α<0° (FIG. 8). The larger WO volume fraction for the malignant tumors was most likely produced by the hypervascularization associated with tumor angiogenesis, but the smaller WO volume fraction for the benign lesions mainly reflected a relatively small amount of increased vascularization associated with benign proliferative breast diseases and fibroadenoma.

Contrast-enhanced MR imaging of the breast has been shown to be very sensitive to breast cancers. The stronger and earlier enhancement followed by a WO behavior for malignant tumors likely reflects their increased vascularity associated with tumor angiogenesis. To examine the kinetic behavior of a lesion, the first important issue is the region of interest used to generate the kinetic curve. It is well recognized that, for a better performance in dynamic MR imaging, it is crucial to evaluate the most-enhanced areas that most likely represent the vital tumor areas within a lesion.

Choosing a large ROI or encompassing the whole lesion into the analysis may average active tumor with necrotic or desmoplastic components of the lesion and consequently may result in a false-negative diagnosis. Accordingly, current kinetic techniques analyze the enhancement rate and curve of a lesion by placing a ROI over the most intensely enhancing area of the lesion. It has been shown that the curve shape is an important differentiator between cancer and benign lesions for comparable enhancement rates and that the WO curve is uniquely suspicious for malignancy. This remarkable kinetic WO behavior of the most-enhanced areas was clearly presented for each one of the malignant tumors in this study. However, it was also clearly presented in the benign lesions as shown in FIG. 6, and consequently it would lead to a false positive diagnosis if the most-enhanced areas were used to generate the kinetic curve.

This similar enhancement behavior in some benign lesions was well recognized, including fibroadenomas, lymph nodes, nonproliferative and proliferative fibrocystic changes. Although the WO curve occurred in both the malignant tumors and the benign lesions, this study found that the WO volume fraction was significantly different between the two groups (FIGS. 7 and 8). This significant different WO volume fraction provides a predictor for differentiating benign from malignant contrast-enhancing breast lesions. It could potentially improve the PPV and consequently reduce the unnecessary biopsies.

In conclusion, the WO volume fraction of a contrast-enhanced lesion was significantly different between the benign lesions and the malignant tumors, providing a sensitive biomarker for differentiating benign from malignant contrast-enhancing breast lesions. Using this WO volume fraction as a predictor, it could significantly improve the PPV and consequently significantly reduce unnecessary biopsies.

The embodiments described herein are exemplary and not intended to be limiting in describing the full scope of compositions and methods of the present technology. Equivalent changes, modifications and variations of embodiments, materials, compositions and methods can be made within the scope of the present technology, with substantially similar results.

What is claimed is:

1. A method for automatically determining an actual boundary of a contrast-enhanced lesion using a dynamic contrast-enhancing magnetic resonance imaging system having a graphical display, a user interface, and a processor, the method comprising:
a. displaying a contrast-enhanced lesion of a first post-contrast image on the graphical display;
b. selecting an outer boundary outside of the lesion and an inner boundary within the lesion on an area surrounding the lesion using the user interface;
c. selecting an initial region of interest located between the inner boundary and the outer boundary to roughly cover the lesion using the user interface;
d. computing a mean (μ) and a standard deviation (σ) of a magnetic resonance signal intensity of voxels within the initial region of interest using the processor;
e. calculating a threshold value TH=μ−N×σ for the initial region of interest;
f. comparing the signal intensity of voxels around the initial region of interest with the threshold value using the processor;
g. modifying the size of the initial region of interest based on the relative signal intensity of voxels in the area adjacent to the initial region of interest as compared to the threshold value to provide an updated region of interest using the processor;
h. comparing the initial region of interest with the updated region of interest and repeating steps (d) through (g) until both regions of interest are substantially the same to automatically determine the boundary of the lesion using the processor; and
i. displaying the actual boundary on the graphical display.

2. The method of claim 1, wherein N is from about 1 to about 3.

3. The method of claim 1, wherein N is about 1.75.

4. The method of claim 1, wherein modifying the size of the initial region of interest further comprises incorporating a voxel into the updated region of interest if the signal intensity of the voxel is larger than the threshold value or excluding the voxel from the updated region of interest if the signal intensity of the voxel is smaller than the threshold value.

5. The method of claim 1, wherein modifying the size of the initial region of interest further comprises incorporating the voxel into the updated region of interest if the voxel is within an area between the inner boundary and the outer boundary.

6. The method of claim 1, further comprising comparing the initial region of interest with the updated region of interest and repeating steps (d) through (g) until both regions of interest are identical in size.

7. The method of claim 1, further comprising replacing the initial region of interest with the updated region of interest prior to repeating steps (d) through (g).

8. The method of claim 1, further comprising assessing whether the lesion is malignant or benign.

9. A method for quantitatively characterizing kinetic features of a contrast-enhanced lesion using a dynamic contrast-enhancing magnetic resonance imaging system having a graphical display, a user interface, and a processor, the method comprising:
a. displaying the contrast-enhanced lesion on the graphical display;
b. computing a linear fitting of a post-contrast signal intensity time course voxel-by-voxel to provide a fitted line with the processor;
c. computing a slope (m) of the fitted line with the processor;
d. computing a corresponding degree of the slope of the fitted line with the processor;
e. displaying the degree of the slope on the graphical display;
f. interpreting the degree of the slope to characterize a wash-out behavior of the lesion; and
g. characterizing the lesion as malignant, benign, or requiring further investigation based on the degree of the slope.

10. The method of claim 9, wherein the linear fitting is conducted using the least squares method.

11. The method of claim 9, wherein the corresponding degree of the slope is the angle between the fitted line and a horizontal axis time line.

12. The method of claim 9, further comprising computing the corresponding degree (α) of the slope using α=atan(m)×180/π.

13. The method of claim 9, wherein a negative value of the degree of the slope indicates wash-out behavior.

14. The method of claim 13, further comprising characterizing the negative value of the degree of the slope as a suspicious malignant lesion.

15. The method of claim 9, wherein a positive value of the degree of the slope value indicates persistent enhancement behavior.

16. The method of claim 15, further comprising characterizing the positive value of the degree of the slope as a suspicious benign lesion.

17. The method of claim 9, further comprising providing a coded display of the degree of the slope distribution for the lesion for visual evaluation.

18. A method for differentiating a benign lesion from a malignant lesion using a dynamic contrast-enhancing magnetic resonance imaging system having a graphical display, a user interface, and a processor, the method comprising:
a. displaying the contrast-enhanced lesion on a graphical display;
b. calculating a lesion volume by summing a total volume of voxels in the lesion using the processor;
c. computing a lesion size using the lesion volume using the processor;
d. identifying wash-out voxels within the lesion using the processor;
e. calculating a wash-out volume by summing a total volume of wash-out voxels within the lesion using the processor;
f. computing a ratio of the wash-out volume and the lesion volume to provide a wash-out volume fraction value using the processor; and
g. comparing the wash-out volume fraction value to a threshold value to characterize the lesion as malignant or benign.

19. The method of claim 18, wherein wash-out is characterized by a negative slope degree as calculated by:
a. computing a linear fitting of a post-contrast signal intensity time course voxel-by-voxel to provide a fitted line;
b. computing a slope (m) of the fitted line;
c. computing a corresponding degree (a) of the slope of the fitted line.

20. The method of claim 18, further comprising selecting a threshold value for defining wash-out.

21. The method of claim 20, further comprising selecting the threshold value for defining wash-out as α<0 degrees.

22. The method of claim 18, further comprising selecting a threshold value for defining wash-out volume fraction.

23. The method of claim 22, further comprising characterizing the lesion as malignant if the wash-out volume fraction value is greater than about 20%.

24. The method of claim 22, further comprising characterizing the lesion as benign if the wash-out volume fraction value is less than about 20%.

25. The method of claim 18, further comprising using a scattered plot of wash-out volume fraction versus lesion size as a criterion for characterizing the lesion.

26. A dynamic contrast-enhancing magnetic resonance imaging system comprising a graphical display, a user interface, and a processor, the system being operable for determining an actual boundary of a contrast-enhanced lesion in a subject using a method comprising:
a. displaying a contrast-enhanced lesion of a first post-contrast image on the graphical display;
b. selecting an outer boundary outside of the lesion and an inner boundary within the lesion on an area surrounding the lesion using the user interface;
c. selecting an initial region of interest located between the inner boundary and the outer boundary to roughly cover the lesion using the user interface;
d. computing a mean (μ) and a standard deviation (σ) of a magnetic resonance signal intensity of voxels within the initial region of interest using the processor;
e. calculating a threshold value TH=μ−N×σ for the initial region of interest;
f. comparing the signal intensity of voxels around the initial region of interest with the threshold value using the processor;
g. modifying the size of the initial region of interest based on the relative signal intensity of voxels in the area adjacent to the initial region of interest as compared to the threshold value to provide an updated region of interest using the processor;
h. comparing the initial region of interest with the updated region of interest and repeating steps (d) through (g) until both regions of interest are substantially the same to automatically determine the boundary of the lesion using the processor; and
i. displaying the actual boundary on the graphical display.

27. The system of claim 26, wherein modifying the size of the initial region of interest further comprises incorporating a voxel into the updated region of interest if the signal intensity of the voxel is larger than the threshold value or excluding the voxel from the updated region of interest if the signal intensity of the voxel is smaller than the threshold value.

28. The system of claim 26, wherein modifying the size of the initial region of interest further comprises incorporating the voxel into the updated region of interest if the voxel is within an area between the inner boundary and the outer boundary.

29. The system of claim 26, wherein the method further comprises comparing the initial region of interest with the updated region of interest and repeating steps (d) through (g) until both regions of interest are identical in size.

30. The system of claim 26, wherein the method further comprises replacing the initial region of interest with the updated region of interest prior to repeating steps (d) through (g).
